(19) United States
(12) Patent Application Publication
(10) Pub. No.: US 2018/0042087 A1
(43) Pub. Date: Feb. 8, 2018

(54) System, Apparatus, and Method for Light Control

(71) Applicant: Echelon Corporation, Santa Clara, CA (US)

(72) Inventor: Mark Keating, Saint Petersburg, FL (US)

(21) Appl. No.: 15/226,778

(22) Filed: Aug. 2, 2016

(51) Int. Cl. H05B 37/02; H05B 37/03; H05B 33/08

(52) U.S. Cl. CPC H05B 37/0227; H05B 37/0272; H05B 33/0887; H05B 37/03; H05B 33/0854; H05B 33/0857; H05B 37/0218

(57) ABSTRACT

Embodiments of systems, methods, and apparatuses for LED lighting for area lighting management, security and safety are described. An exemplary apparatus comprises a plurality of light emitting diodes (LEDs); a LED controller to drive the plurality of LEDs; and a controller to receive a radio frequency (RF) LED drive command and communicate the received drive command to the LED controller, wherein the LED controller to drive the plurality of LEDs according to the received drive command.

### FIELD OF INVENTION

The field of invention relates generally to device control, and, more specifically, to the control of lightbulbs.

### BACKGROUND

Many open office space areas are very large. For example, in an area of 30,000 sq./ft. there may be 100-200 partitioned work spaces. Most open office area lighting is controlled by a few switches or circuit breakers for the whole space. This provides an all or nothing approach to controlling overhead lights in theses spaces.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of a light bulb;

FIG. 2 illustrates another embodiment of a bulb;

FIG. 3 illustrates another embodiment of a bulb using a single microcontroller;

FIG. 4 illustrates an embodiment of a wireless controller;

FIG. 5 illustrates an embodiment of memory of a wireless controller;

FIG. 6 illustrates an embodiment of profiles used by a wireless controller software;

FIG. 7 illustrates an embodiment of network used by a wireless controller software;

FIG. 8 illustrates a collection of bulbs into a group;

FIG. 9 illustrates a collection of groups of bulbs into a large group;

FIG. 10 illustrates an embodiment of a server to communicate with one or more bulbs;

FIG. 11 illustrates exemplary embodiments placement of wireless controllers in bulbs;

FIG. 12 illustrates an embodiment of a device communicating with a bulb;

FIG. 13 illustrates an embodiment of a method performed by a bulb;

FIG. 14 illustrates an embodiment of a method performed by a bulb;

FIG. 15 illustrates an embodiment of a method performed on a device external to the bulb;

FIG. 16 illustrates an embodiment of a method performed on a device external to the bulb;

FIG. 17 illustrates an embodiment of a method performed by a bulb;

FIG. 18 illustrates an embodiment of using bulb occupancy information;

FIG. 19 illustrates an embodiment of flow involving bulbs and a CMS; and

FIG. 20 illustrates, in block diagram form, an exemplary processing system to perform event planning and events as detailed herein.

[1]

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

There are numerous approaches to try to control lighting at an individual work area level which generally include strategically placed passive infrared (PIR) motion sensors above the work space and then wiring the light fixtures to try to confine their control based on connecting motion sensors to specific lighting fixture(s). This is expensive and hard to do. Additionally, if the freestanding work spaces are moved around, all the wiring must be modified to maintain the previous amount of control. Detailed below are embodiments of systems, apparatuses, and method to provide control of lights on an individual and/or group basis.

Most of the light provided from ceiling fixtures mounted above work areas originates from T-8 fluorescent bulbs. Typically, there are four bulbs in a fixture with more than one fixture above the work space. Replacing the T-8 fluorescent bulbs in the fixtures with T-8 LED replacement bulbs that are each equipped with an embedded, wireless controller in each individual bulb allows benefits such as eliminating most, if not all, control wiring for the bulbs.

Bulbs can be grouped within fixtures (e.g., 4/fixture) and fixtures can be grouped into work spaces, etc. All fixtures (and even individual bulbs) are networkable such that a controller on each floor and/or a Central Management System (CMS) can provide the operating properties that the “occupied” work space may use to control their lights within the work space. Further, the CMS could provide all control if needed.

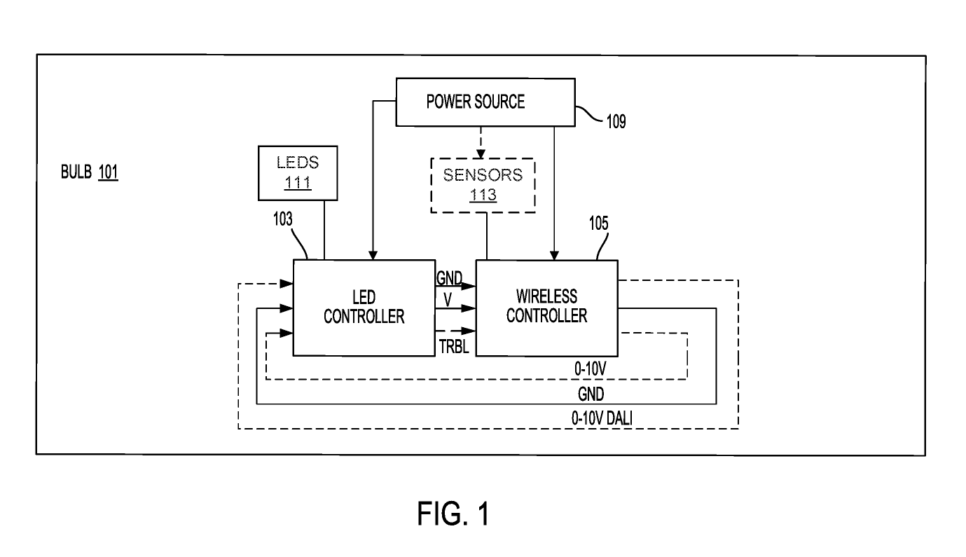

FIG. 1 illustrates an embodiment of a light bulb. This bulb is of any shape with any connector (for electrical or network connectivity) including, but not limited to, a series e.g., A19, r series, t series (T8, T14, etc.), coil, par series, etc. The bulb includes at least one base connector such as a screw base (E10, E11, E12, E14, E17, E26, E27, etc.), twist & lock base, bi pin base, fluorescent bin base (e.g., mini bi-pin, recessed DC, medium bi-pin, single bi-pin, etc.), compact fluorescent plug in lamp base, etc. Typically, this bulb 101 includes a plurality of light emitting diodes (LEDs) 111. An LED controller 103 includes circuitry to drive the LEDs 111. The driver circuitry may be a sink or a source and varies depending upon the standard used by the bulb. In the IEC standard 60929, the LED driver circuitry sources the current, and the control sinks the current. At 10V, LEDs will be on at full, and at 1V or below, LEDs go to a minimum level, not necessarily off. With the ESTA (Entertainment Services & Technology Association) E1.3 standard, the control sources the current, and the driver sinks the current. At 10V, LEDs will be on at full, and at 0V or below, LEDs go to off.

Depending upon the embodiment, the LED controller 103 provides one or more of the following functions for the LEDs 111: 0-10V dimming control, white tuning (2 0-10V connections), digital addressable lighting interface (DALI) control, and on/off functionality and expanded digital control using Pulse Width Modulation (PWM) or other digital LED control techniques.

Coupled to LED controller 103 is a wireless controller 105. The wireless controller 105 provides a function for the delivery of commands to the LED controller 103. For example, the wireless controller 105 provides a command to turn off or on the bulb, dim the bulb, or provide color changing by passing embedded commands transmitted using the wireless connection. In some embodiments, the LED controller 103 supports one or more of 0-10V dimming control, white tuning, or DALI control. The wireless controller 105 includes one or more radio frequency (RF) components to receive lighting commands from RF devices such as Bluetooth® and Bluetooth® Low Energy (BLE) (such as that maintained by Institute of Electrical and Electronics Engineers (IEEE) standard 802.15.1 and the Bluetooth SIG); Wi-Fi (IEEE 802.11); INSTEON; Infrared Data Association (IrDA); wireless USB; z-wave; Radio Frequency for Consumer Electronics (RF4CE); and ZigBee (IEEE 802.15.4 based) devices and communicate those commands to the LED controller 103. Typically, the RF device in communication with the bulb 101 is a wireless personal area network (WPAN) device. In some embodiments, the wireless controller 105 is a system on a chip (SOC). In other embodiments, the wireless controller 105 is a collection of one or more discrete components.

In some embodiments, commands handled by a bulb are relatively simple. For example, turning off/on, dimming, changing color, etc. However, in other embodiments, commands handled by the bulb are more complex. For example, a command may include one or more additional attributes including, but not limited to, duration, priority, frequency, etc. As an example, a command may indicate that a bulb is to be turned on for a duration of 10 minutes before turning off at a frequency of every hour unless a command of a higher priority is received. As other examples, a command may cause a bulb to dim for 5 or 10 minutes before turning off, or only allow the bulb to come on when a sensor indicates more light is needed, only allow a light to come on only if motion was recently detected, etc.

In some embodiments, the LED controller 103 provides a ground and a direct current (DC) voltage to the wireless controller 105. For example, the LED controller 103 provides 3.3 Volts to power the wireless controller 105. The LED controller may also provide an indication of trouble with one or more of the LEDs via one or more of overcurrent or overvoltage detection circuits.

Additionally, in some embodiments, a power source 109 is included to power some or all of the wireless controller 105, sensors 113, and LED controller 103. Typically, this power source 109 converts AC voltage to DC voltage to power the controller(s) and/or sensors.

In some embodiments, the power source 109 includes power storage to provide power when power from wiring coupled to the bulb is not available. Examples of power sources include a battery, capacitor, super capacitor, etc.

In some embodiments, a bulb 101 includes one or more sensors 113. For example, the bulb 101 may include one or more photosensors, temperature sensors, motion sensors, etc.

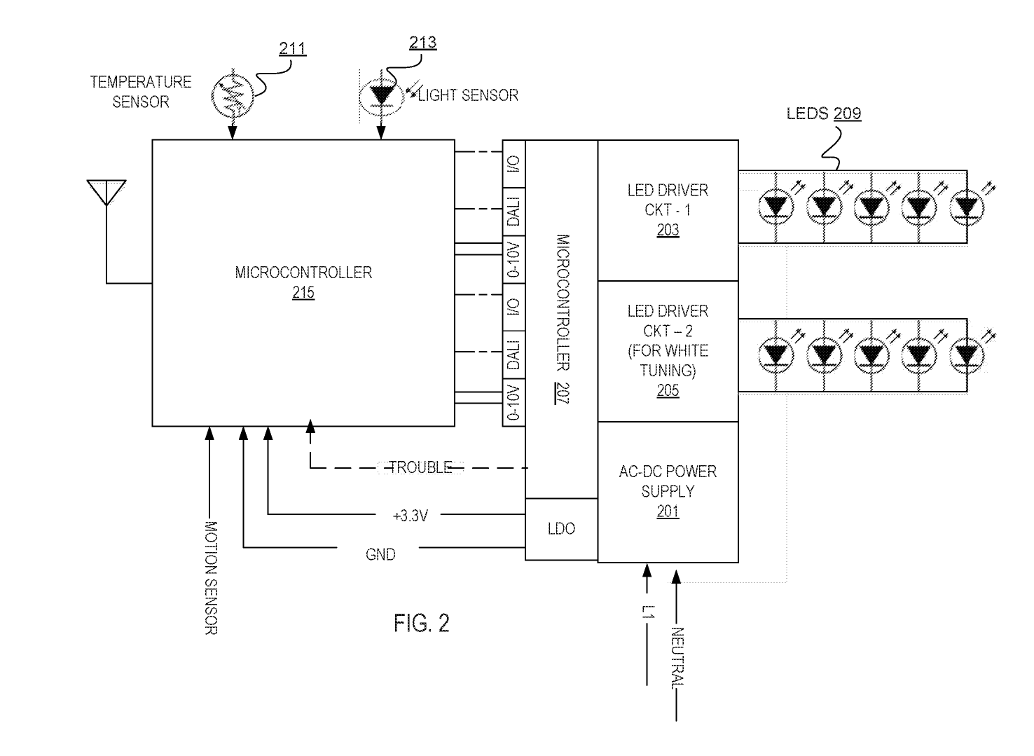

FIG. 2 illustrates another embodiment of a bulb. This bulb is of any shape including, but not limited to, a series (e.g., A19, r series, t series (T8, T14, etc.), coil, par series, etc. The bulb includes at least one base connector such as a screw base (E10, E11, E12, E14, E17, E26, E27, etc.), twist & lock base, bi pin base, fluorescent bin base (e.g., mini bi-pin, recessed DC, medium bi-pin, single bi-pin, etc.), compact fluorescent plug in lamp base, etc. Typically, this bulb includes a plurality of light emitting diodes (LEDs) 209. A controller 207 includes circuitry to drive the LEDs driver circuits 203 and/or 205 upon receiving a command from a wireless controller 215. The driver circuitry may be a sink or a source and varies depending upon the standard used by the bulb. In the IEC standard 60929, the LED driver circuitry sources the current, and the control sinks the current. At 10V, LEDs will be on at full, and at 1V or below, LEDs will go to a minimum level (dim), but not necessarily be off (note that 0 Volts the LEDs will be off). With the ESTA (Entertainment Services & Technology Association) E1.3 standard, the control sources the current, and the driver sinks the current. At 10V, LEDs will be on at full, and at 0V or below, LEDs go to off.

Coupled to controller 207 is a wireless controller 215. The wireless controller 215 provides a function for the controller 207 to take. For example, the wireless controller 215 provides a command to turn off or on the bulb, dim the bulb, or provide color changing by passing embedded commands transmitted using the wireless connection. Depending upon the embodiment, the controllers provide one or more of the following functions for the LEDs 111: 0-10V dimming control, white tuning (2 0-10V connections), digital addressable lighting interface (DALI) control, and on/off functionality and expanded digital control using Pulse Width Modulation (PWM) or other digital LED control techniques.

The wireless controller 215 includes one or more radio frequency (RF) components to receive lighting commands from RF devices such as Bluetooth® and Bluetooth® Low Energy (BLE) (such as that maintained by Institute of Electrical and Electronics Engineers (IEEE) standard 802.15.1 and the Bluetooth SIG); Wi-Fi (IEEE 802.11); INSTEON; Infrared Data Association (IrDA); wireless USB; z-wave; Radio Frequency for Consumer Electronics (RF4CE); and ZigBee (IEEE 802.15.4 based) devices and communicate those commands to the controller 207. Typically, the RF device in communication with the bulb is a wireless personal area network (WPAN) device. In some embodiments, the wireless controller is a system on a chip (SOC).

In some embodiments, commands handled by a bulb are relatively simple. For example, turning off/on, dimming, changing color, etc. However, in other embodiments, commands handled by the bulb are more complex. For example, a command may include one or more additional attributes including, but not limited to, lighting duration, control priority, frequency characteristics of the lighting (as an example every day on in the morning, dim at noon and off in the evening), etc. As an example, a command may indicate that a bulb is to be turned on for a duration of 10 minutes before turning off at a frequency of every hour unless a command of a higher priority is received.

A ground and a direct current (DC) voltage are provided by a power supply 201. to the wireless controller 215. For example, 3.3 Volts are supplied to power the wireless controller 215. The controller 207 may also provide an indication of trouble with one or more of the LEDs via one or more of overcurrent or overvoltage detection circuits.

Additionally, one or more sensors (temperature 211, light 213, and/or motion) are provided in some embodiments.

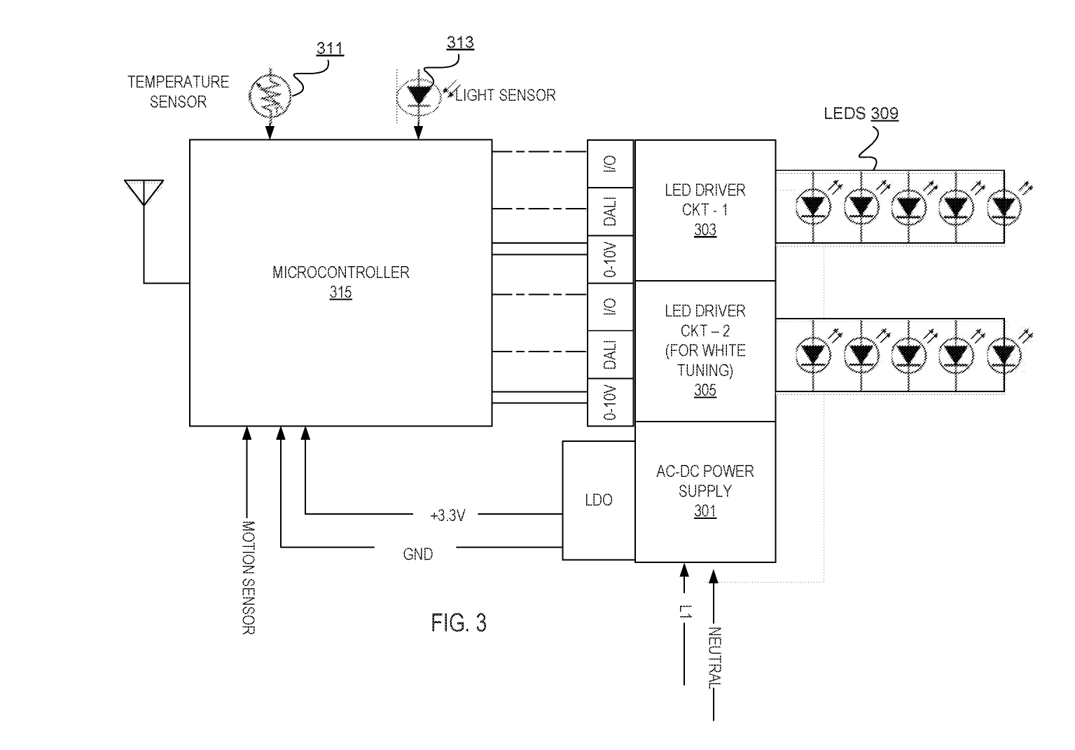

FIG. 3 illustrates another embodiment of a bulb using a single microcontroller. This bulb is of any shape including, but not limited to, a series (e.g., A19, r series, t series (T8, T14, etc.), coil, par series, etc. The bulb includes at least one base connector such as a screw base (E10, E11, E12, E14, E17, E26, E27, etc.), twist & lock base, bi pin base, fluorescent bin base (e.g., mini bi-pin, recessed DC, medium bi-pin, single bi-pin, etc.), compact fluorescent plug in lamp base, etc. Typically, this bulb includes a plurality of light emitting diodes (LEDs) 309. A wireless controller 315 includes circuitry to drive the LEDs driver circuits 303 and/or 305 upon receiving a command from a wireless controller 315. The driver circuitry may be a sink or a source and varies depending upon the standard used by the bulb. In the IEC standard 60929, the LED driver circuitry sources the current, and the control sinks the current. At 10V, LEDs will be on at full, and at 1V or below, LEDs go to a minimum level, not necessarily off. With the ESTA (Entertainment Services & Technology Association) E1.3 standard, the control sources the current, and the driver sinks the current. At 10V, LEDs will be on at full, and at 0V or below, LEDs go to off.

The wireless controller 315 provides a function for the drivers 303 and 305 to take. For example, the wireless controller 315 provides a command to turn off or on the bulb, dim the bulb, or provide color changing by passing embedded commands transmitted using the wireless connection. Depending upon the embodiment, the controllers provide one or more of the following functions for the LEDs: 0-10V dimming control, white tuning (2 0-10V connections), digital addressable lighting interface (DALI) control, and on/off functionality and expanded digital control using Pulse Width Modulation (PWM) or other digital LED control techniques.

The wireless controller 315 includes one or more radio frequency (RF) components to receive lighting commands from RF devices such as Bluetooth® and Bluetooth® Low Energy (BLE) (such as that maintained by Institute of Electrical and Electronics Engineers (IEEE) standard 802.15.1 and the Bluetooth SIG); Wi-Fi (IEEE 802.11); INSTEON; Infrared Data Association (IrDA); wireless USB; z-wave; Radio Frequency for Consumer Electronics (RF4CE); and ZigBee (IEEE 802.15.4 based) devices and communicate those commands to the LED driver circuits. Typically, the RF device in communication with the bulb is a wireless personal area network (WPAN) device. In some embodiments, the wireless controller is a system on a chip (SOC).

In some embodiments, commands handled by a bulb are relatively simple. For example, turning off/on, dimming, color adjustment, etc. However, in other embodiments, commands handled by the bulb are more complex. For example, a command may include one or more additional attributes including, but not limited to, duration, priority, frequency, etc. As an example, a command may indicate that a bulb is to be turned on for a duration of 10 minutes before turning off at a frequency of every hour unless a command of a higher priority is received.

A ground and a direct current (DC) voltage are proved by a power supply 301 to the wireless controller 315. For example, 3.3 Volts are supplied to power the wireless controller 315. The controller 307 may also provide an indication of trouble with one or more of the LEDs via one or more of overcurrent or overvoltage detection circuits.

Additionally, one or more sensors (temperature 311, light 313, and/or motion) are provided in some embodiments.

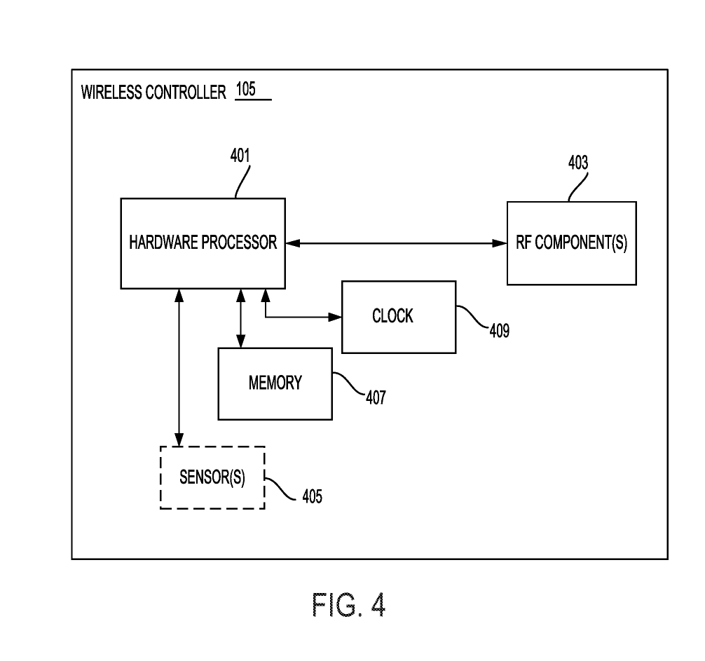

FIG. 4 illustrates an embodiment of a wireless controller. As illustrated, wireless controller 105 includes a hardware processor (such as a microcontroller or central processing unit (CPU)) 401 to process software in the form of executable instructions.

Memory 407 stores software to be executed by the processor 401, one or more lighting profiles, network information, and, in some embodiments, a clock routine.

RF components 403 include analog RF and/or base-band circuitries to receive and transmit data (typically as packets). These circuits are coupled to one or more antennas such as PCB trace antennas. In some embodiments, the RF components support Bluetooth Low Energy (BLE).

In some embodiments, the RF components 403 include a separate processor to process incoming and outgoing data. For example, the processor packetizes data for outgoing transmission and de-packetizes incoming packets to extract data to pass to the processor 401. However, in some embodiments, this functionality is provided by processor 401.

In some embodiments, the wireless controller 105 includes at least one sensor 405. For example, an included temperature sensor detects temperature of the bulb itself (the LED array(s) of the bulb) and an included light sensor detects LED light. These sensors allow for diagnostics to detect non-operating bulbs based on temperature and light levels sensed.

In some embodiments, the wireless controller 105 includes a real-time clock (RTC) 409 to track current time. For example, a RTC circuit tracks time for the wireless controller.

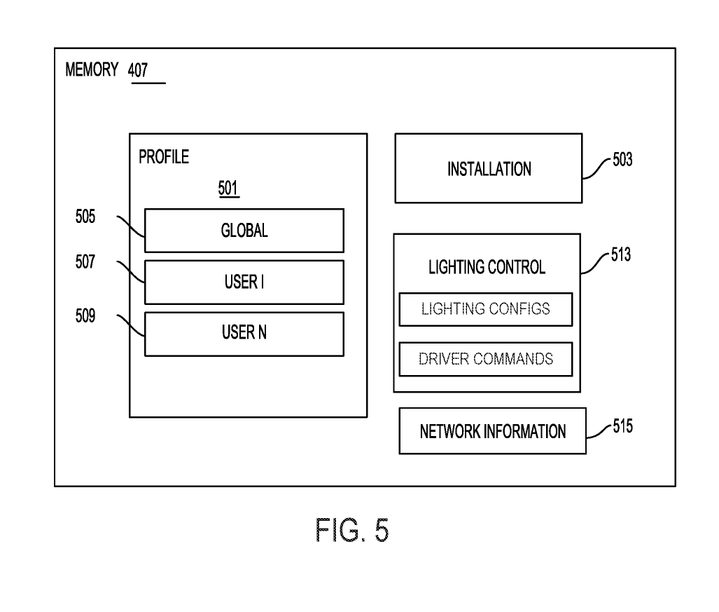

FIG. 5 illustrates an embodiment of memory controller to store bulb related data. In many embodiments, the memory is a part of a system on a chip (SOC) of a wireless controller. However, in other embodiments, the memory is external to a wireless controller SOC. The memory 407 may be non-volatile (such as flash, etc.), volatile, or a combination thereof. One or more profiles 501 are stored in memory. These profiles 501 (such as a global profile 505 and user profiles 507-509) are used by lighting control software 513 to handle received RF commands and provide LED driver commands to the LED controller 103. In some embodiments, a LED driver command is a part of a lighting configuration. Lighting configurations provide one or more LED driving commands (examples of which have been previously detailed) to be given to one or more LED driver circuits of the bulb based upon a state of a set of one or conditions. An example of a lighting configuration is as follows, for user 1, under the condition of the time being from 8 AM-9 AM, increase the intensity of the LEDs of the bulb. Another example of a lighting configuration is if a neighboring bulb is outputting too much light (as determined by the bulb's sensor), then reduce the intensity of the LEDs of the bulb, else leave the LEDs as they are currently set. In some embodiments, a bulb comes with preset lighting configurations. In some embodiments, light configurations are user or administrator configurable.

The lighting control software 513 is also used to update profiles 501 and network information 515 (which stores information about what group the bulb belongs to), and respond to requests for the stored information. Lighting control software 513 may also include one or more lighting configurations.

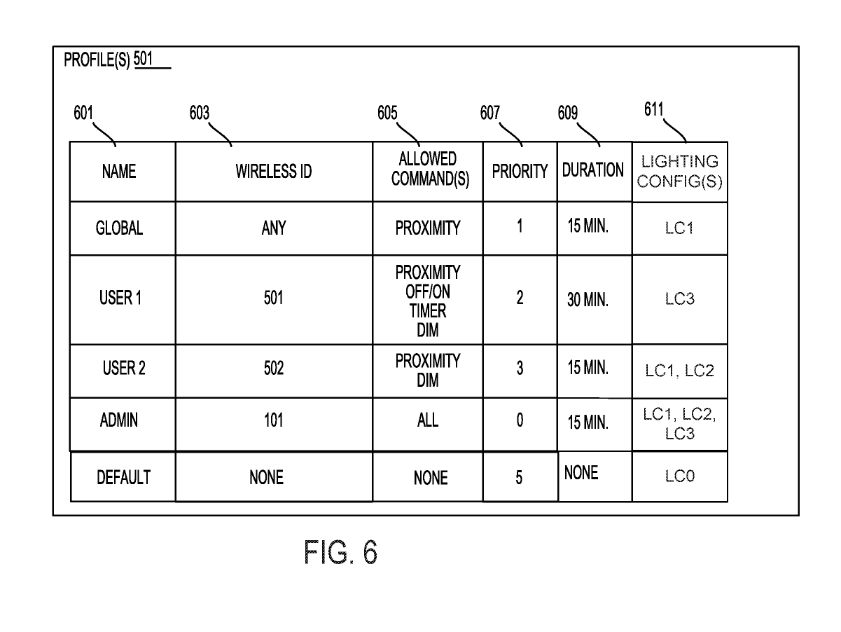

Installation software 503 provides a routine to handle installation/configuration of the bulb. Memory also stores a device identifier for the bulb. Memory 407 may also store a listing of capabilities of the bulb (what dimming it supports, etc.). FIG. 6 illustrates an embodiment of profiles used by a wireless controller software. A bulb may have one to many profiles 501. In some embodiments, by default, with no configuration, the bulb is to operate as normal bulb without any capability of being wirelessly controlled. In other embodiments, a global profile allows any wireless user that communicates with the bulb to use proximity to control the bulb. For example, when the user's device communicates with the bulb, the bulb turns on for a set duration.

Each non-default profile includes a name 601, at least one wireless identifier 603 associated with the profile, allowed commands 605, a relative priority 607, and a duration counter 609. Names 601 indicate who the profile is associated with, such as a particular user or group. Wireless IDs 603 are IDs provided to the bulb associated with one or more user devices. For example, media access control (MAC) addresses of cell phones that have BLE connectivity to talk to the bulb.

Allowed commands 605 may include, but are not limited to, commands for on/off, dim (0-10 or DALI), color adjustment, and timer; and proximity based (turn on/off) commands.

In some embodiments, profiles are given a relative priority 607 such that if conflicting profiles could be applied (for example, two users are communicating with the bulb) the profile given higher priority (shown with a lower number in the figure) will be used.

Finally, a duration (counter) 609 may be set for each profile in some embodiments. For example, after 15 minutes the wireless controller waits for contact, or attempts to make contact, with the profile device that provided a command (either explicit or by proximity). In some embodiments, when no contact is made, a default command is taken (such as turn off the bulb). When contact is made, the duration (counter) is reset.

In some embodiments, a profile contains a link to one or more lighting configurations 611, or lighting configurations themselves.

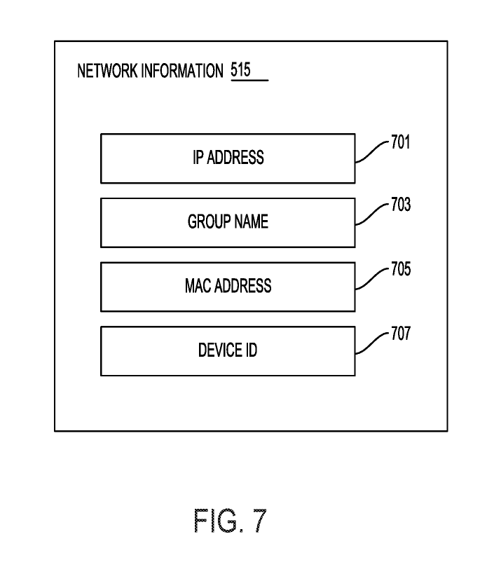

FIG. 7 illustrates an embodiment of network used by a wireless controller software. The network information 515 includes one or more of an IP address 701 of the bulb, a group name 703 that the bulb belongs to, a MAC address 705 of the bulb, and a device ID 707 of the bulb. The network information may also include a log of device connectivity (occupancy) with other devices (e.g., what device connected, for how long, and when the connection took place).

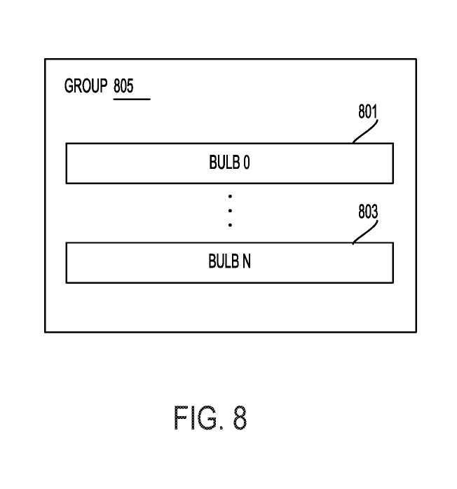

FIG. 8 illustrates a collection of bulbs into a group. In the group 805 there are bulbs 801-803. A grouping is sometimes called a piconet. Typically, the group includes a master bulb and slave bulbs which follow the master bulb. In some embodiments, the group of bulbs connect to each other in an ad hoc fashion.

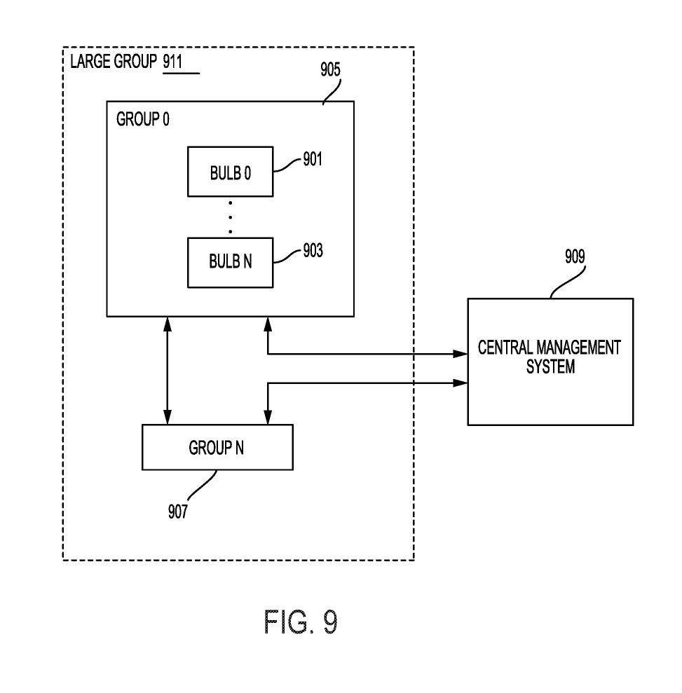

FIG. 9 illustrates a collection of groups of bulbs into a large group. A first group (bulbs 901-903) and a second group N 907 form a larger group 911 (sometimes called a scatternet). These groups are interconnected using one of the bulbs from the second group. The bulbs participating in both groups 905, 907 relays data between members of groups.

The large group 911 (or each group individually) may communicate with a central management system (CMS) 909. The CMS 909 may provide the operating properties to the bulbs (either directly or via an application on a user device) and may provide all control if needed. Further, each bulb may provide the CMS 909 with occupancy status information for the space beneath it. It could provide “who” was there, when they were there, how long they were there, etc. for use in security management.

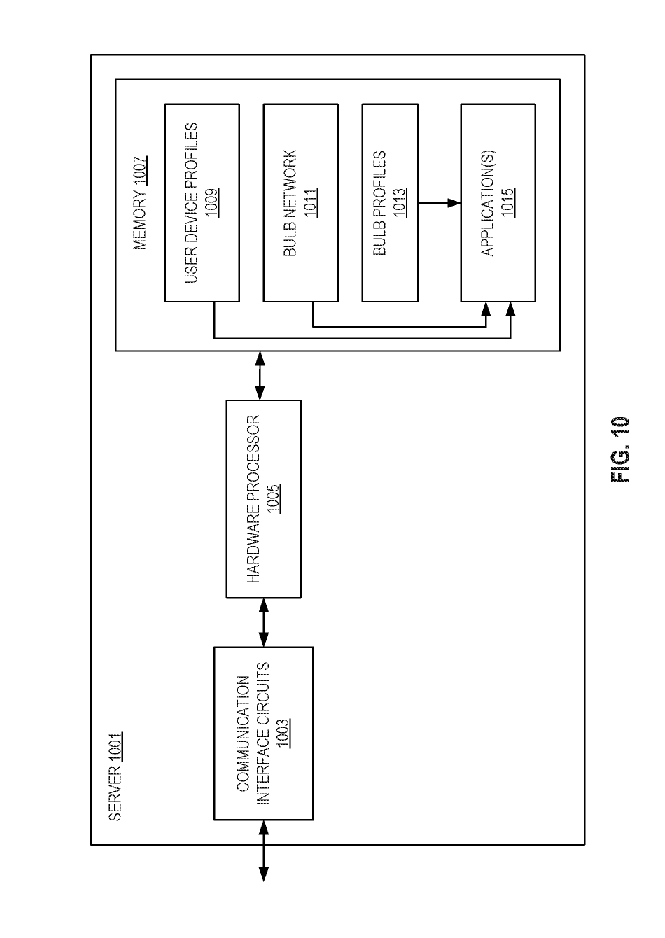

FIG. 10 illustrates an embodiment of a server to communicate with one or more bulbs. For example, the server 1001 is a CMS. In an embodiment, the CMS is a part of an on-demand computing environment.

The server includes communication interface circuitry 1003 to communicate with one or more bulbs. Exemplary communication interfaces include, but are not limited to, Bluetooth® and Bluetooth® Low Energy (BLE) (such as that maintained by Institute of Electrical and Electronics Engineers (IEEE) standard 802.15.1 and the Bluetooth SIG); Wi-Fi (IEEE 802.11); INSTEON; Infrared Data Association (IrDA); wireless USB; z-wave; Radio Frequency for Consumer Electronics (RF4CE); ZigBee (IEEE 802.15.4 based); powerline communication (PLC); Ethernet; USB; etc.

The server 1001 includes a hardware processor 1005 to execution programs/applications/routines 1015 stored in memory 1007. Exemplary applications are detailed later. Memory 1007 may also store user device profiles (such a default profile and individual profiles) 1009, bulb network information (location, type, sub-network, etc.) 1011, and bulb profiles (configured bulb information) 1013. The applications 1015 may use one or more of these during execution.

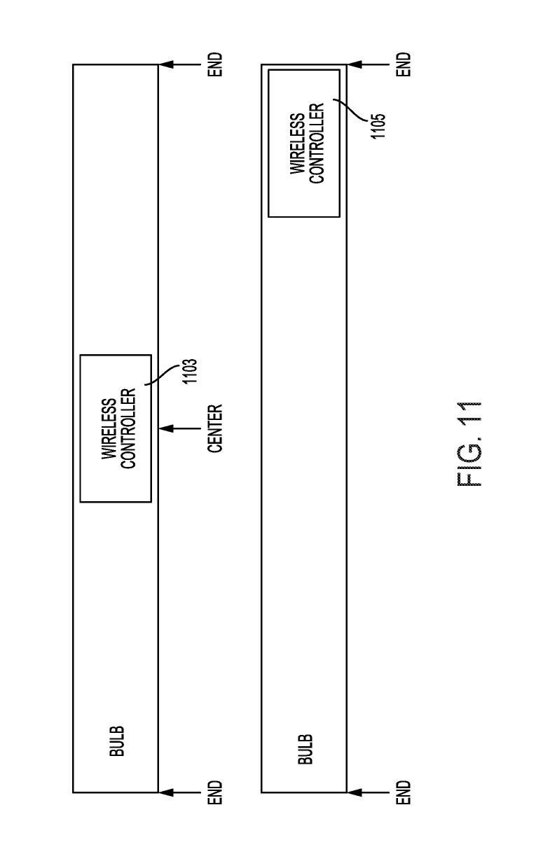

FIG. 11 illustrates exemplary embodiments, placement of wireless controllers in bulbs. The top embodiment shows a wireless controller 1103 close to the center of the bulb. The bottom embodiment shows a wireless controller 1105 close to an end of the bulb. The placement of the wireless controller can facilitate the formation of piconets and scatternets guided by signal strength information.

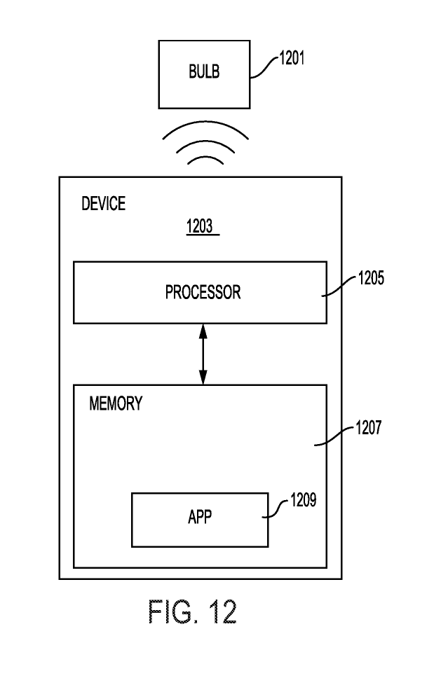

FIG. 12 illustrates an embodiment of a device communicating with a bulb. The device 1203 (such as a Bluetooth enabled phone, computer, etc.) includes a processor 1205 and memory 1207 to store an application 1209 used to communicate with the bulb 1201 via RF components of the device 1203. The application 1209 allows a user to control the bulb 1201 according to a profile of the bulb 1201. The application 1209 may also include a configuration routine to configure aspects of the bulb (such as adding the bulb to a group, configuring a profile, etc.).

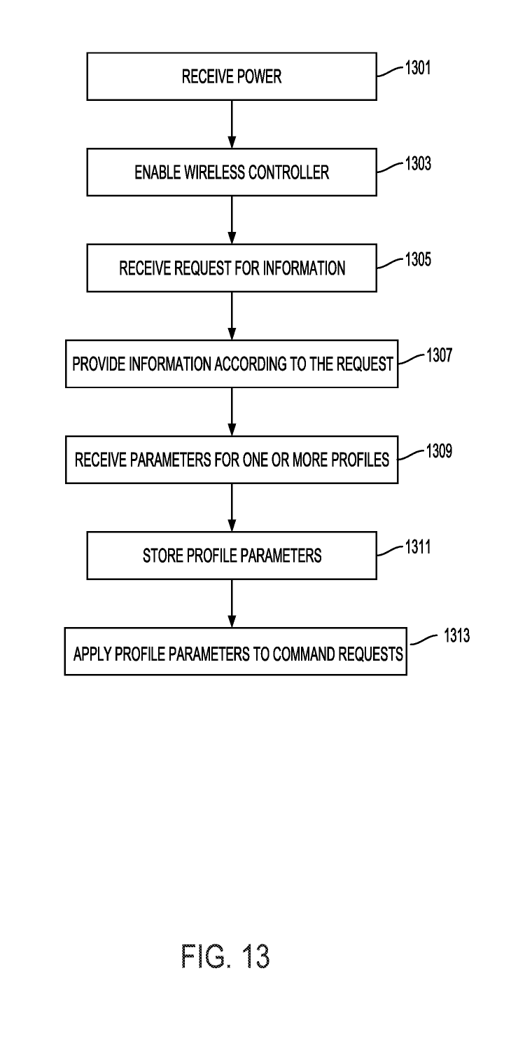

FIG. 13 illustrates an embodiment of a method performed by a bulb. At 1301, the bulb receives power. This allows the different components to power on including the wireless controller which is powered up and enabled at 1303. In some embodiments, the wireless controller is powered by a source internal to the bulb and does not need external power to turn on.

The wireless controller receives a request for information at 1305. For example, an external device (such as a Bluetooth enabled smartphone, tablet, or computer) transmits a request that is received by RF components of the wireless controller. This request for information typically asks for the device ID of the bulb as stored by the wireless controller. The request may also ask for any profiles stored by the wireless controller and/or the capabilities of the bulb (what dimming it supports, etc.).

The wireless controller provides the information according to the request at 1307. For example, the wireless controller provides its device ID.

At 1309, the wireless controller receives configuration parameters for one or more profiles. For example, an external device (such as a Bluetooth enabled smartphone, tablet, or computer) transmits parameters for a profile that is received by RF components of the wireless controller.

The received profile parameters are stored into memory of the wireless controller at 1311.

At some point later in time, the wireless controller applies stored profile parameters to a command request and directs the LED controller to perform a command (turn off/on, dim, etc.) at 1313.

Note that the above may be repeated per bulb in a group or large group, or the bulb in communication with the external device may pass the information, commands, etc. to the other bulbs in the group or large group. Additionally, in some embodiments, when a new bulb is added to fixture it is made a slave and inherits profiles, etc. from the master bulb.

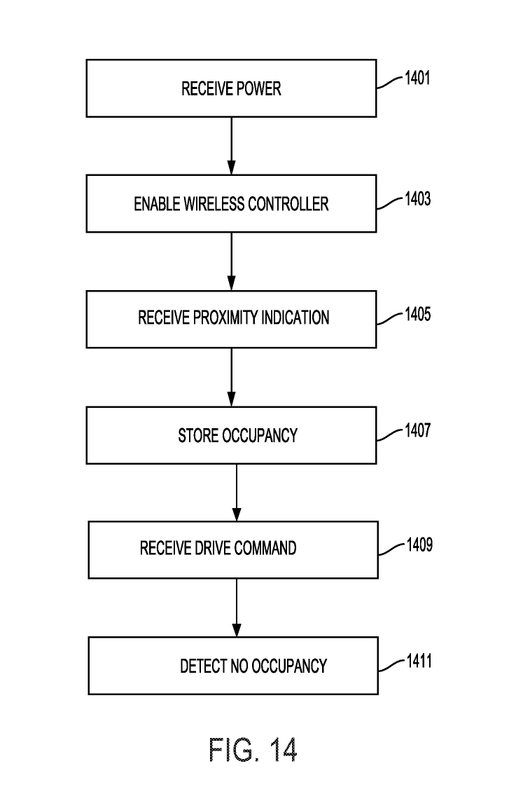

FIG. 14 illustrates an embodiment of a method performed by a bulb dealing with proximity. At 1401, the bulb receives power. This allows the different components to power on including the wireless controller which is powered up and enabled at 1403. In some embodiments, the wireless controller is powered by a source internal to the bulb and does not need external power to turn on.

The wireless controller receives a proximity indication at 1405. For example, an external device (such as a Bluetooth enabled smartphone, tablet, or computer) communicates with RF components of the wireless controller to alert the wireless controller of its presence. In some embodiments, one or more defined packets are received from the external device to indicate a desire to communicate with the wireless controller.

In some embodiments, at 1407, the wireless controller stores occupancy information related to the proximity indication.

At 1409, a LED drive command is received, and, if allowed, the LED drive command is provided to the LED controller to be performed. For example, an LED drive command of dim, turn off/on, color adjusting command, etc. is received and provided to the LED controller. When a higher prioritized profile does not allow for the command (or the command is priority pre-empted), it is not provided to the LED controller. The prioritized profile is a profile that is currently deemed to have the highest priority. Note, the LED drive command could simply be proximity based such that when the prioritized profile allows for proximity based commands (e.g., turn on/off) that command is performed without any explicit LED drive command being received.

At some point later in time, the wireless controller detects that there is no device in proximity for a set duration at 1411. For example, after 15 minutes the wireless controller attempts to make contact with the profile device that provided a command (either explicit or by proximity). When no contact is made, a default command is taken (such as turn off the bulb). Note that the above may be repeated per bulb in a group or large group, or the bulb in communication with the external device may pass the information, commands, etc. to the other bulbs in the group or large group.

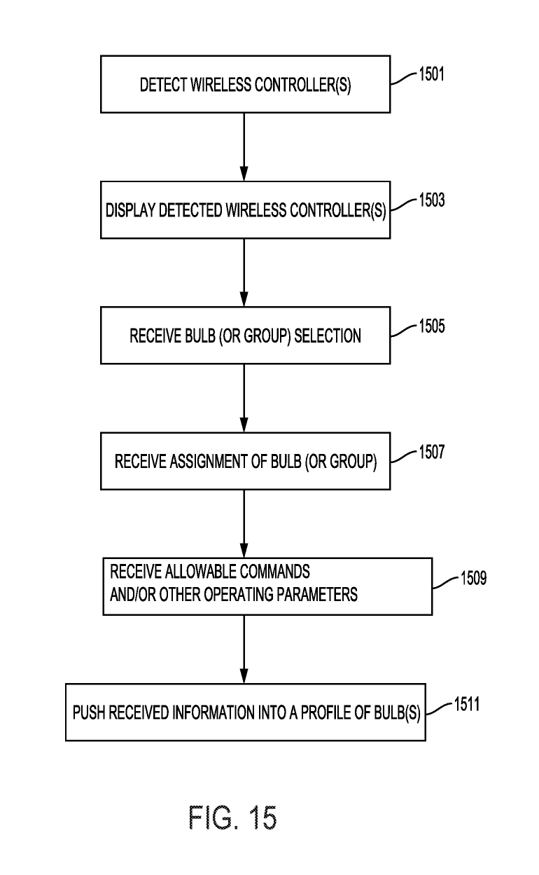

FIG. 15 illustrates an embodiment of a method performed on a device external to the bulb. For example, embodiments of this method are performed on an application of a smartphone, tablet, or computer that is enabled to wirelessly communicate with the bulb. Typically, the application is received from a CMS.

At 1501, one or more wireless controllers of bulbs are detected. This detection could be the result of a user initiated scan, or occur automatically without user intervention. Typically, a fixture will have more than one bulb (for example, four bulbs) that are to be configured as a group.

The detected wireless controllers of bulbs are displayed at 1503. The display order may be done in many different ways including, but not limited to, by bulb name (device ID), signal strength, etc.

At 1505, a bulb (or group) selection is received. For example, a user taps on a bulb in the application to select that bulb (or group that it belongs to).

In some embodiments, for example during installation of a bulb, at 1507, an assignment of a bulb (or group) is made. For example, a bulb is assigned to profile USER 1.

At 1509, allowable commands and/or other profile parameters (e.g., name) are received by the application.

The information received at 1509, is pushed (sent) to the selected bulb at 1511 to be stored in a profile.

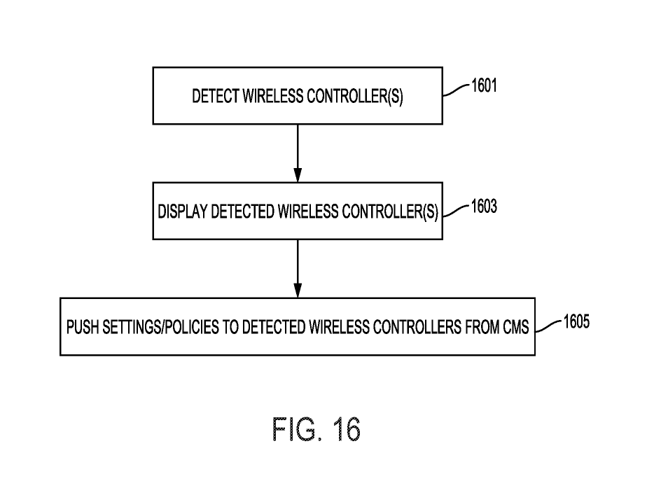

FIG. 16 illustrates an embodiment of a method performed on a device external to the bulb. For example, embodiments of this method are performed on an application of a smartphone, tablet, or computer that is enabled to wirelessly communicate with the bulb. Typically, the application is received from a CMS and is specific to the user.

At 1601, one or more wireless controllers of bulbs are detected. This detection could be the result of a user initiated scan, or occur automatically without user intervention. Typically, a fixture will have more than one bulb (for example, four bulbs) that are to be configured as a group.

The detected wireless controllers of bulbs are displayed at 1603. In some embodiments, the application is programmed with a filter to only show wireless controllers of bulbs that the user is allowed to control.

Settings/policies are pushed (sent) to detected wireless controllers at 1605 without user intervention. For example, a user may not have privileges to change or set his/her own profile, but the application has one designed for the user to be added to the wireless controllers assigned to the user.

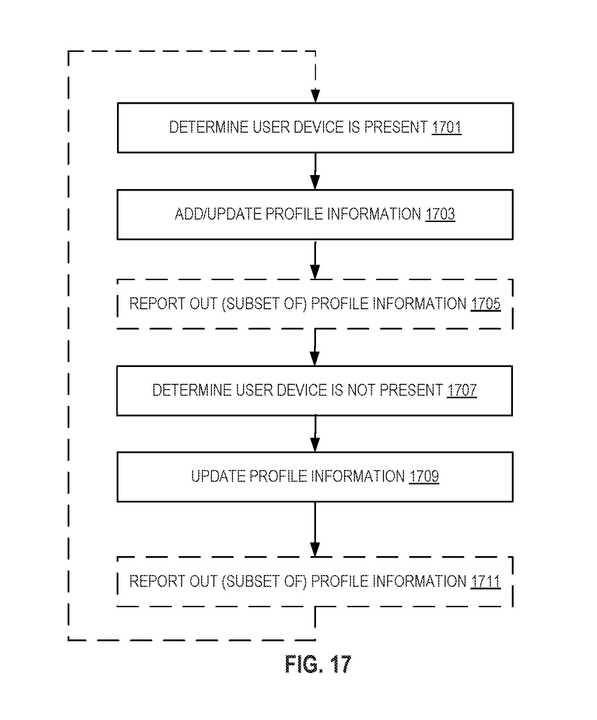

FIG. 17 illustrates an embodiment of a method performed by a bulb. A determination of a user device (e.g., a mobile device) being present is made at 1701. Depending up on the implementation of the bulb, this detection may be made several different ways. For example, in some embodiments, the bulb acts as a proximity reporter with a user device that acts as a proximity monitor. The proximity monitor creates connection with the proximity reporter and monitors Radio Signal Strength Information (RSSI). If there is no connection with the proxy monitor, there is no user device present.

Presence information is stored in a profile (for example, in a user profile as detailed previously) at 1703. Exemplary information may include the user device's ID, the time of connection, the duration of the connection, etc. This information may be an update to an existing profile or a new profile creation.

In some embodiments, at least some of the profile information is reported out at 1705. For example, the profile information is sent to a server for storage and/or evaluation. The report out may be automatic or polled depending upon the implementation.

At some point later in time, a determination is made that the user device is not present near the bulb at 1707. For example, a proximity monitor has not communicated with the proximity reporter for a period of defined time. This time may be stored in the profile as a duration as detailed earlier.

Presence information is stored in a profile (for example, in a user profile as detailed previously) at 1709. Exemplary information may include the user device's ID, the time of connection, the duration of the connection, etc. This information may be an update to an existing profile.

In some embodiments, at least some of the profile information is reported out at 1711. For example, the profile information is sent to a server for storage and/or evaluation. The report out may be automatic or polled depending upon the implementation.

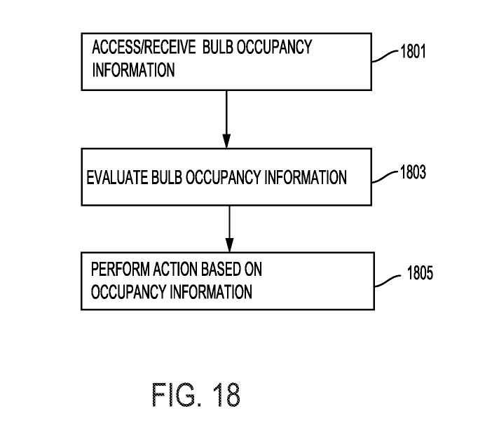

The use of presence information allows for many use cases. FIG. 18 illustrates an embodiment of using bulb occupancy/presence information. Typically, this is performed by an entity other than a bulb, such as a server. At 1801, occupancy/presence information from one or more bulbs is accessed and received by a third party (such as a control management service). For example, “who” was there, when they were there, how long the person was there, unknown user presence, etc. are pulled/pushed as one or more profiles of the bulb are accessed.

This allows for questions to be answered such as are there u not associated with a profile that were in proximity with the bulb, who was not there that should have been (for example, a user has a profile but should not have been in the room that had the bulb), who was not there that should have been (for example, a user has a profile and should have been in the room that had the bulb at a certain point in time, but was not), etc. At 1803, an evaluation of the occupancy/presence information is made to determine an action. There are many different scenarios (examples are detailed herein). For example, the profile information is subject to one or more sets of rules to determine a potential action.

In some embodiments, filters are used to reduce or eliminate redundant information and adjust starting presence and ending presence through time stamps from the first detection of an individual to finding out the individual has left the space. As an example, the earliest someone is detected in a conference room can be obtained by overlay any existing data about that individual with information about an earlier connection indication. An individual is detected leaving with the later connection indication, etc. Collected information can be periodically sent to a CMS or sent on demand by a CMS or hand-held device etc.

At 1805, an action is performed/invoked based at least on the occupancy/presence information. The action may be in the form of a command sent from the server to a bulb to perform, etc. This action may be lighting based or not. As an example of a lighting action, usage patterns of a user may be used to configure lighting for that user. For example, when an employee returns to work in the evening, or at night, a path can be lit up from his entry point to his desk based on his past patterns of activity as recorded by the bulbs. Another example is when a visitor wants to meet with an employee, after a possible security check, a command causes the lighting to change colors, dim, brighten, or flash, etc. that marks a trail that leads the visitor to the employee's desk. Another example is a parking lot or structure/garage where individual lights could monitor for “presence” or “absence.” The lights would know over specific time frames similar to the previous use case (for conference rooms and auditoriums etc.), but also track a user movement through the parking structure and preference for parking spots. This information can be globally correlated across all the lights would give usage peaks and valleys, travel routes through the parking structure, patterns of parking spot usage, popular spots and idle spots, and lead to ideas to optimize traffic flows within the structure. Patterns to all parking spots by all employees (or shoppers) would be learned over time and as each car enters the parking structure lights could lead them to the optimal open space for them (the open space closest to where they usually park). A final example is lighting a path during a fire to an exit to lead a person out of danger. These scenarios are programmed either in the bulbs themselves (stored in memory) or at a server to be pushed to the bulbs that are affected. In addition, the collected information about user triggered lighting activity and paths can be mined further using analysis techniques such as big data analysis.

Non-lighting examples are numerous. For example, HVAC can be controlled based on the knowledge of both occupancy and number of people present in a space at any time. For example, a security action such as flashing lights over an unauthorized person (or following that person) may be taken based upon occupancy. Presence information may also be used as an alert that there is a potential health or security issue. If user device connects with a bulb for an extended period of time or at an unusual time that is considered abnormal that may indicate a security or health issue. For example, someone at his desk very late at night that has not moved may trigger a flashing overhead light as a guide for emergency medical services (EMS), or the CMS to send a message (e.g., short messaging service, email, phone call, etc.) to the individual or building management, and/or initiate a 911 call, etc.

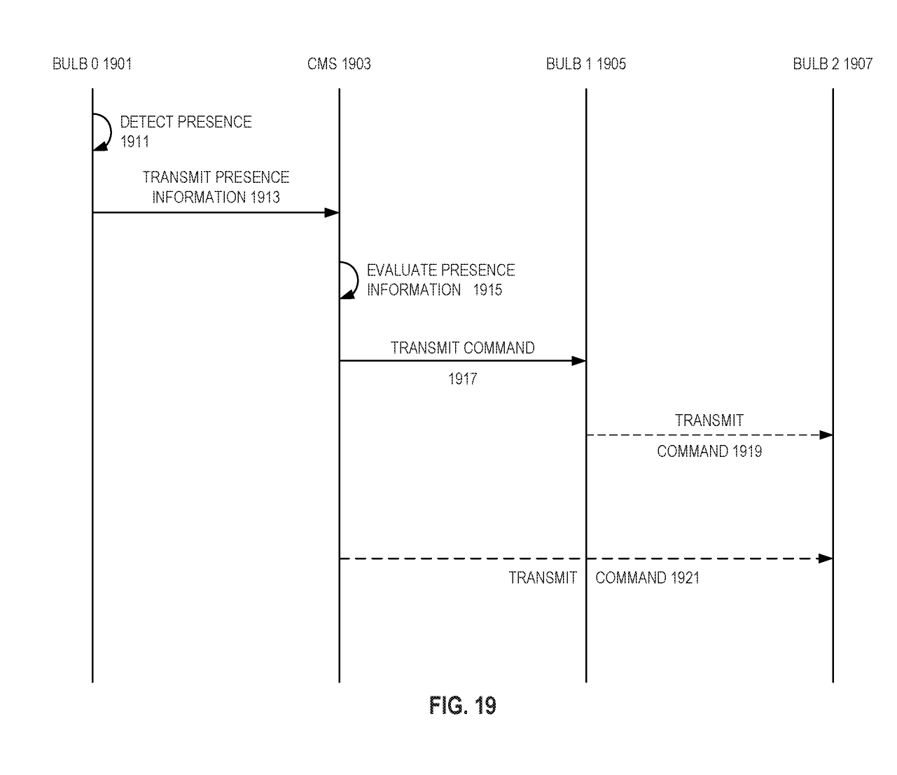

FIG. 19 illustrates an embodiment of flow involving bulbs and a CMS. A first bulb (bulb 0) 1901 detects a presence of a device (as detailed earlier) at 1911. The bulb transmits information about the presence detection at 1913 to a CMS 1903. This information typically involves one or more data points of a profile as detailed earlier.

The CMS 1903 evaluates the received information at 1915 as detailed earlier. The CMS 1903 then sends a command to at least one bulb (bulb 1 1905) at 1917. For example, a command to turn on the bulb is made.

In some embodiments, the receiving bulb (bulb 1 1905) transmits a command to another bulb (bulb 2 1907) at 1919. This could be the same command or a different command. For example, bulb 1 1905 may transmit a command to bulb 2 1907 to execute at a certain point in time (e.g., tracking a user's path).

In some embodiments, the CMS 1903 transmits a command to another bulb (bulb 2 1907) at 1921. This could be the same command or a different command. For example, CMS 1903 may transmit a command to bulb 2 1907 to execute at a certain point in time (e.g., tracking a user's path).

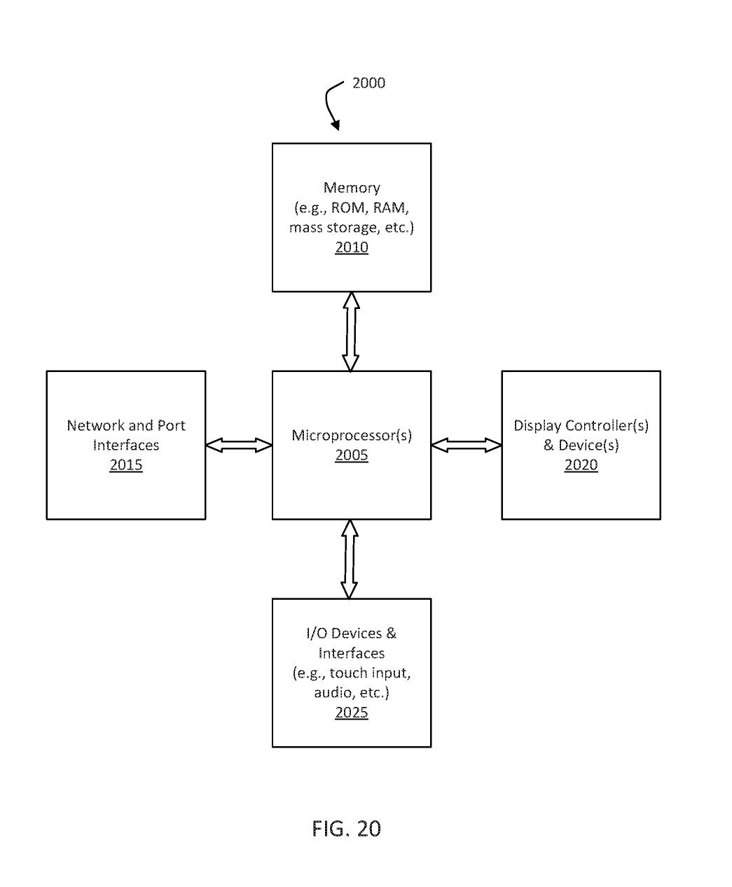

FIG. 20 illustrates, in block diagram form, an exemplary processing system. Data processing system 2000 includes one or more microprocessors 2005 and connected system components (e.g., multiple connected chips). Alternatively, data processing system 2000 is a system on a chip.

Data processing system 2000 includes memory 2010, which is coupled to microprocessor(s) 2005. Memory 2010 may be used for storing data, metadata, and programs for execution by the microprocessor(s) 2005 including embodiments of the methods detailed above. For example, memory 2010 may include one or more of the profiles described herein. Memory 2010 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 2010 may be internal or distributed memory.

Data processing system 2000 includes network and port interfaces 2015, such as a port, connector for a dock, or a connector for a USB interface, FireWire, Thunderbolt, Ethernet, Fibre Channel, etc. to connect the system 2000 with another device, external component, or a network. Exemplary network and port interfaces 2015 also include wireless transceivers, such as an IEEE 802.11 transceiver, an infrared transceiver, a Bluetooth transceiver, a wireless cellular telephony transceiver (e.g., 2G, 3G, 4G, etc.), or another wireless protocol to connect data processing system 2000 with another device, external component, or a network and receive stored instructions, data, tokens, etc.

Data processing system 2000 also includes display controller and display device 2020 and one or more input or output (“I/O”) devices 2025. Display controller and display device 2020 provides a visual user interface for the user. I/O devices 2025 allow a user to provide input to, receive output from, and otherwise transfer data to and from the system. I/O devices 2025 may include a mouse, keypad or a keyboard, a touch panel or a multi-touch input panel, camera, optical scanner, audio input/output (e.g., microphone and/or a speaker), other known I/O devices or a combination of such I/O devices.

Data processing system 2000 is an exemplary representation of one or more of the systems detailed described above. Data processing system 2000 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, data processing system 2000 may be a network computer, server, or an embedded processing device within another device or consumer electronic product. As used herein, the terms computer, device, system, processing system, processing device, and “apparatus comprising a processing device” may be used interchangeably with data processing system 2000 and include the above-listed exemplary embodiments.

Additional components, not shown, may also be part of data processing system 2000, and, in certain embodiments, fewer components than that shown may also be used in data processing system 2000. It will be apparent from this description that aspects of the inventions may be embodied, at least in part, in software. That is, the computer-implemented method(s) detailed herein may be carried out in a computer system or other data processing system 2000 in response to its processor or processing system executing sequences of instructions contained in a memory, such as memory 2010 or other non-transitory machine-readable storage medium. The software may further be transmitted or received over a network (not shown) via network and port interfaces 2015. In various embodiments, hardwired circuitry may be used in combination with the software instructions to implement the present embodiments. Thus, the techniques are not limited to any specific combination of hardware circuitry and software, or to any particular source for the instructions executed by data processing system 2000.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. An apparatus comprising:
a plurality of light emitting diodes (LEDs);
a LED driver circuit to drive the plurality of LEDs;
a controller circuit to receive a radio frequency (RF) commands and communicate a second command to the LED driver circuit, wherein the LED driver circuit to drive the plurality of LEDs according to a received command; and
at least one sensor circuit to determine a status of the apparatus.

2. The apparatus of claim 1, wherein the at least one sensor circuit is a photo sensor to determine an amount of light received by the apparatus.

3. The apparatus of claim 1, wherein the at least one sensor circuit is a temperature sensor to determine a temperature of the apparatus.

4. The apparatus of claim 1, wherein the controller circuit to output a 0-10V control signal to the LED driver circuit.

5. The apparatus of claim 1, wherein the controller circuit to output a digital addressable lighting interface command to the LED driver circuit.

6. The apparatus of claim 1, wherein the controller circuit to output an on/off command to the LED driver circuit.

7. The apparatus of claim 1, wherein the controller circuit to output a pulse width modulation (PWM) command to the LED driver circuit.

8. The apparatus of claim 1, further comprising:
a microcontroller coupled to the LED driver circuit to receive the second command and send a third command to the LED driver circuit.

9. The apparatus of claim 8, wherein the microcontroller to output a trouble indication to the controller circuit upon an indication of a LED failure.

10. The apparatus of claim 9, wherein the LED failure is detected by an overcurrent circuit.

11. The apparatus of claim 9, wherein the LED failure is detected by an overvoltage circuit.

12. The apparatus of claim 8, wherein the controller circuit to receive a trouble indication upon an indication of LED failure.

13. The apparatus of claim 1, wherein the controller circuit is located in approximately a center of a LED bulb.

14. The apparatus of claim 1, wherein the controller circuit to transmit a RF command.

15. An apparatus comprising:
a controller circuit to receive a radio frequency (RF) command and communicate a second command to a LED driver circuit, wherein the LED driver circuit to drive a plurality of LEDs according to a received command; and
at least one sensor circuit to determine a status of the apparatus.

16. The apparatus of claim 15, wherein the at least one sensor circuit is a photo sensor to determine an amount of light received by the apparatus.

17. The apparatus of claim 15, wherein the at least one sensor circuit is a temperature sensor to determine a temperature of the apparatus.

18. The apparatus of claim 15, wherein the controller circuit to output a 0-10V control signal to the LED driver circuit.

19. The apparatus of claim 15, wherein the controller circuit to output a digital addressable lighting interface command to the LED driver circuit.

20. The apparatus of claim 15, wherein the controller circuit to output an on/off command to the LED driver circuit.

21. The apparatus of claim 15, wherein the controller circuit to output a pulse width modulation (PWM) command to the LED driver circuit.

22. The apparatus of claim 21, wherein the controller circuit to receive a trouble indication upon an indication of LED failure.

23. The apparatus of claim 21, wherein the LED failure is detected by an overcurrent circuit.

24. The apparatus of claim 21, wherein the LED failure is detected by an overvoltage circuit.

25. The apparatus of claim 15, wherein the controller circuit is located in approximately a center of a LED bulb.

26. The apparatus of claim 15, wherein the controller circuit to transmit a RF command.

27. A method comprising:
receiving user device presence information for at least one light bulb;
evaluating the received user device presence information for at least one light bulb to determine an action; and
invoking an action based upon the evaluation of the received user device presence information for at least one light bulb.

28. The method of claim 27, wherein the user device presence information includes at least one of an indication of what user communicated with the at least one light bulb, when the user communicated with the at least one light bulb, and how long the user was in communication with the at least one light bulb.

29. The method of claim 27, wherein the action is to send a command to one or more light bulbs to light up a path for a user to follow.

30. The method of claim 29, wherein the evaluation indicates a potential health issue when the user communicates with the at least one light bulb in an abnormal manner.

31. The method of claim 30, wherein the action is to send an alert to medical personnel.

32. The method of claim 27, wherein the action is to send a command to one or more light bulbs in accordance with a profile associated with the user device.

33. The method of claim 27, wherein the user device presence information includes an indication of an unknown user presence.

34. The method of claim 33, wherein the action is to send a command to one or more light bulbs to flash over the unknown user presence.

35. The method of claim 34, wherein the at least one light bulb to flash over the unknown user presence as the unknown user presence moves.
